(19) United States
(12) Patent Application Publication
(10) Pub. No.: US 2026/0170258 A1
(43) Pub. Date: Jun. 18, 2026

(54) SELECTIVE VIRTUAL ASSISTANT RESPONSES

(71) Applicant: WELLS FARGO BANK, N.A., San Francisco, CA (US)

(72) Inventors: Priyanka Khanna, Needham, MA (US); Bradley Stewart, Danville, CA (US); Prakash Bhatta, Clarksburg, MD (US); Jayachandra reddy Kamineni, Charlotte, NC (US); Shahram Khosraviani, Charlotte, NC (US); Lena Maksad, Edison, NJ (US); Rungson Samroengraja, Cornelius, NC (US); Sundarapandian Sethuramachandran, Chandler, AZ (US); Michael Shehata, Budd Lake, NJ (US); Kevin Cole, Charlotte, NC (US); Paulina Cueva, New York City, NY (US); Alicia Jones-McFadden, Fort Mill, SC (US); William Bailey, Cornelius, NC (US)

(21) Appl. No.: 18/980,823

(22) Filed: Dec. 13, 2024

(51) Int. Cl. G06F 40/35; G06F 40/205; G06F 40/40; G06N 5/04

(52) U.S. Cl. CPC G06F 40/35; G06F 40/205; G06F 40/40; G06N 5/04

(57) ABSTRACT

A method for utterance analysis for selective virtual assistant responses includes: receiving a text input; determining, using a first language model, an intent associated with the text input; receiving, by the first language model, a first list of predefined intents and a second list of select intents, wherein each predefined intent is associated with a respective predefined response; comparing the determined intent to the first list of predefined intents and to the second list of select intents to determine a respective first match or a respective second match; responsive to determining the respective first match, retrieving and outputting the respective predefined response; responsive to determining the respective second match, providing the text input and a prompt to a second language model; and generating and outputting a generative response to the text input using the second language model.

### TECHNICAL FIELD

The present disclosure generally relates to natural language processing, and more particularly to utterance analysis for selective virtual assistant responses.

### BACKGROUND

Natural language processing (“NLP”) techniques employing machine learning (“ML”) models are a core component in natural language understanding (“NLU”), enabling development of effective virtual assistant applications. ML models are trained on vast datasets to draw inferences on human-like text. One type of ML model used for this purpose is a large language model (“LLM”) which can provide more accurate, relevant, and context-aware responses, significantly improving user interactions and satisfaction. Despite the recent advances in the field of NLP, there is a need in the art for improved utterance analysis techniques for selective virtual assistant responses.

### SUMMARY

Certain aspects and features of the present disclosure generally relate to natural language processing, and more particularly to utterance analysis for selective virtual assistant responses. According to an aspect of the present disclosure, a method of utterance analysis for selective virtual assistant responses includes: receiving a text input associated with a virtual interaction; determining, using a first language model, an intent associated with the text input; receiving, by the first language model, a first list of predefined intents and a second list of select intents, wherein each predefined intent of the first list of predefined intents is associated with a respective predefined response from a list of predefined responses; comparing the determined intent to the first list of predefined intents and to the second list of select intents to determine a respective first match or a respective second match; responsive to determining the respective first match, retrieving and outputting the respective predefined response; responsive to determining the respective second match, providing the text input and a prompt to a second language model; and generating and outputting a generative response to the text input using the second language model.

In some examples, the text input comprises a plurality of words, each word comprising a plurality of characters, and the method further comprises: parsing, using the first language model, the text input to determine a total number of characters associated with the text input; and responsive to determining that the total number of characters does not satisfy a threshold, generating and outputting an indication that the text input is non-compliant. In some other examples, the virtual interaction is an online chat session and wherein the virtual interaction comprises real-time chat messages in the online chat session.

In some examples, the method further comprises: determining a validity of the generative response by: computing, using the second language model, a confidence score associated with the generative response; evaluating the confidence score against one or more threshold confidence scores; responsive to determining the confidence score satisfies the one or more threshold confidence scores, tagging the generative response as valid as outputting the generative response; and responsive to determining the confidence score does not the one or more threshold confidence scores, generating a new generative response using the second language model by providing an updated prompt and the text input to the second language model.

In some examples, the method further comprises: responsive to generating and outputting the generative response, receiving a new text input from a user; extracting a second intent from the new text input; and generating and outputting, based on the second intent, a second response, wherein the second response is retrieved from the list of predefined responses or the second response is generated by the second language model.

In some examples, the method further comprises retrieving, using the second language model, session data associated with the virtual interaction, wherein the generative response is generated at least in part based on the session data, wherein the session data is associated with a user account associated with a user of the virtual interaction.

In some examples, the method further comprises: responsive to determining that the determined intent is not included in the first list of predefined intents or the second list of select intents, labeling the determined intent as an unrecognized intent; storing the unrecognized intent in a datastore comprising a plurality of unrecognized intents; clustering the plurality of unrecognized intents using a classification model to thereby generate one or more clusters, each respective cluster comprising a subset of unrecognized intents; responsive to the subset of unrecognized intents of a respective cluster satisfying a threshold, assigning a new select intent to the respective cluster; and adding the new select intent to the second list of select intents. In some examples, the method includes prior to processing the text input, the first language model and the second language model were generated by fine-tuning respective instances of a pre-trained language model, and wherein the method further comprises: fine-tuning the second language model based in part on the new select intent. In some examples, determining the intent is performed by comparing the text input to a set of predetermined keywords.

The above methods may be implemented in a cloud service executed on cloud service provider infrastructure, which may include various servers, processors, and databases. The above methods can also be implemented as computer-executable program instructions stored in a non-transitory, tangible computer-readable medium or media and/or operating within a system including one or more processors or other processing device and memory.

An additional example includes a system including one or more processors. The system also includes a memory coupled to the one or more processors. The memory includes instructions that when executed by the one or more processors, causes the one or more processors to: receive a text input associated with a virtual interaction; determine, using a first language model, an intent associated with the text input; receive, by the first language model, a first list of predefined intents and a second list of select intents, wherein each predefined intent of the first list of predefined intents is associated with a respective predefined response from a list of predefined responses; compare the determined intent to the first list of predefined intents and to the second list of select intents to determine a respective first match or a respective second match; responsive to determining the respective first match, retrieve and output the respective predefined response; responsive to determining the respective second match, provide the text input and a prompt to a second language model; and generate and output a generative response to the text input using the second language model.

An additional example includes a non-transitory computer-readable medium embodying program code that is executable by one or more processors to cause the one or more processors to: receive a text input associated with a virtual interaction; determine, using a first language model, an intent associated with the text input; receive, by the first language model, a first list of predefined intents and a second list of select intents, wherein each predefined intent of the first list of predefined intents is associated with a respective predefined response from a list of predefined responses; compare the determined intent to the first list of predefined intents and to the second list of select intents to determine a respective first match or a respective second match; responsive to determining the respective first match, retrieve and output the respective predefined response; responsive to determining the respective second match, provide the text input and a prompt to a second language model; and generate and output a generative response to the text input using the second language model.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is an example system that can establish a virtual communication session to provide for utterance analysis for selective virtual assistant responses, according to one or more aspects of the present disclosure;

FIG. 2 is an example data flow diagram for a virtual assistant platform that provides for utterance analysis for selective virtual assistant responses, according to one or more aspects of the present disclosure;

FIG. 3 is a flowchart of an example of a process that provides for utterance analysis for selective virtual assistant responses, according to one or more aspects of the present disclosure;

FIG. 4 is a block diagram illustrating an example computer-readable medium or computer-readable device including processor-executable instructions configured to embody one or more aspects of the present disclosure; and

FIG. 5 and the following discussion provide a description of a suitable computing environment to implement embodiments of one or more aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

Virtual assistant applications have become a common way for people to obtain information or perform actions. People can interact with a virtual assistant from their personal computers, mobile phones, or otherwise, and provide requests (e.g., text inputs) to a virtual assistant. The virtual assistant can process the text input and generate a response answering the user request, performing an action on behalf of the user, etc. One illustrative example of the present disclosure includes a virtual assistant platform for utterance analysis for selective virtual assistant responses. The virtual assistant platform includes a first language model that can perform intent classification on a text input received by a user interacting with a virtual assistant hosted by the virtual assistant platform. The first language model employing intent classification utilizes one or more ML models to determine an underlying purpose or goal of the text input. Intent classification is a core component of NLU systems, enabling such virtual assistants, chatbots, etc. The first language model is trained on a dataset of user requests paired with their respective intent labels. The first language model learns to extract relevant features from the text input, such as keywords, phrases, and grammatical structure. Based on these extracted features, the first language model may classify the user's text input into one or more predefined intents.

As part of the virtual assistant platform, a datastore stores a list of predefined intents indicating intents that the virtual assistant platform is capable of generating a response to. A first sub-list of the list of predefined intents includes default intents where the virtual assistant platform has a predefined response. A second sub-list of the list of predefined intents includes select intents where the virtual assistant platform does not have a predefined response, but the virtual assistant platform is configured to use a generative model to generate a response to the request. The determined intent, e.g., determined by the first language model, is compared to the list of intents to determine a match.

In the case where the determined intent matches an intent included in the first sub-list of predefined intents (e.g., a default intent), the virtual assistant platform retrieves the predefined response from a datastore. The predefined response is then output for display on a client device associated with the user in response to the request.

In the case where the determined intent matches an intent included in the second sub-list of predefined intents (e.g., a select intent), the virtual assistant utilizes a second language model to provide a generative response to the request. The second language model may be a trained ML model of any suitable type that has been trained to provide natural language responses to text inputs. For example, the second language model can be a large language model (“LLM”) such as Language Model for Dialogue Applications (or “LaMDA”) (such as Google Gemini), ChatGPT-3, ChatGPT-3.5, ChatGPT-4, DeepMind Sparrow, Claude 3, including future versions of any of these or other LLMs suitable to generate a generative response.

Because generative response generation employs any suitable LLM which accepts natural language queries and prompts, the second language model is provided with a prompt including constraints to enable the generated response to be tailored according to the preferences of a particular user or administrator of the virtual assistant platform. For instance, one type of constraint can instruct the second language model to consider session data accessible by the second language model. The session data can include user account information, information gleaned from publicly available websites, or documents stored in a datastore of the virtual assistant platform.

Additionally, because generative models such as the second language model may have a propensity to hallucinate (e.g., generate irrelevant or incomprehensible responses), various post-filtering checks can be performed on the generated response to validate the generated response accuracy. For instance, one type of post-filtering check involves computing a confidence score associated with the generated response and performing a threshold analysis. More specifically, the second language model may also compute a confidence score associated with the generated response (e.g., using probabilities, log probabilities, the softmax function, or using other similar confidence metrics). The confidence score may be interpreted as a reliability and accuracy level of the second language model generated response. After generating the confidence score, the confidence score may be compared to a threshold, and in one particular example, if the confidence score is greater than the threshold, the threshold is satisfied, and the generated response is output for display on a client device associated with the user in response to the request.

In the case where the determined intent does not match an intent in the list of predefined intents, the intent is labeled as unrecognized. In response, the virtual assistant platform may output an indication to the user that the request could not be processed. As described in more detail below, unrecognized intents may be stored in a datastore of the virtual assistant platform for future processing. For instance, when a certain number of common unrecognized intents surpasses a threshold, the virtual assistant platform may retrain the first language model to be configured to handle such unrecognized intents, and the list of intents may be updated accordingly.

After the request is processed and a response is generated, e.g., by virtue of providing a default response, a generative response 282, or an indication that the determined intent is unrecognized or unable to be processed, the virtual assistant platform monitors for additional requests (e.g., additional text inputs) from the client device 130. If additional requests are received, the virtual assistant platform begins the intent determination processing steps again. The virtual interaction with the virtual assistant platform continues until the user has no more requests or the client device associated with the user disconnects from the virtual assistant platform.

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods are provided below in relation to the drawings.

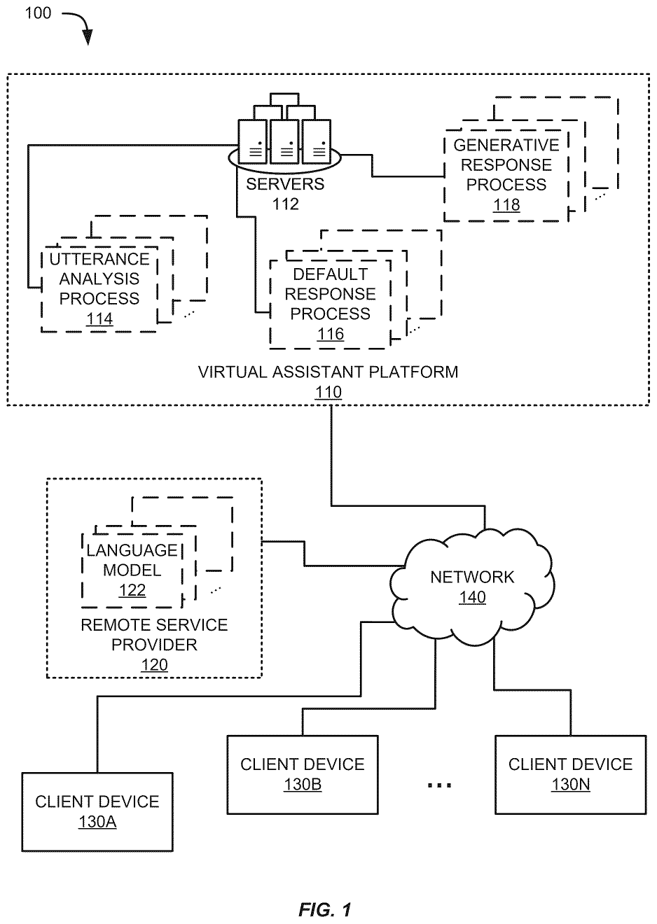

Referring now to FIG. 1, FIG. 1 is an example system 100 that can establish a virtual communication session. In this example system 100, a virtual assistant platform 110 and a number of client devices 130A-130N (which may be referred to herein individually as a client device 130 or collectively as the client devices 130) are connected via a network 140. Network 140 can be the internet, or any suitable communications network or combination of communications network may be employed, including LANs (e.g., within a corporate private LAN), WANs, MANs, cellular network (e.g., 3G, 4G, 4G LTE, 5G, etc.), or any combination of these.

The client devices 130A-130N can be any suitable computing or communications device. For example, client devices 130A-130N may be desktop computers, laptop computers, tablets, smart phones having processors and computer-readable media, connected to the virtual assistant platform 110 using the internet, via a smartphone or desktop application, or other suitable computer network. The client devices 130A-130N have communication software installed to enable them to connect to the virtual assistant platform 110 to chat with a virtual assistant hosted by the virtual assistant platform 110 to ask the virtual assistant platform 110 questions or have the virtual assistant platform 110 perform tasks on their behalf such as accessing one or more accounts associated with a user of the client devices 130A-130N, messaging, and any other suitable communications.

The virtual assistant platform 110 operates a number of servers 112 that can provide the virtual assistant functionality for the virtual communication session. As shown in FIG. 1, virtual assistant functionality is provided by one or more instances of utterance analysis processes 114, default response processes 116, and generative response processes 118 that can be executed and allocated to or used by virtual assistant sessions hosted by the one or more servers 112 of the virtual assistant platform 110 for the various client devices 130A-130N. Further, and although not shown in FIG. 1, some of the processes hosted by virtual assistant platform 110 may employ one or more trained ML models to facilitate the virtual assistant functionality described herein. For example, the utterance analysis processes 114 and generative response processes 118 may employ trained ML models of any suitable type. In some examples, the trained ML model utilized by the utterance analysis processes 114 may be an intent classification model such as Dual Intent and Entity Transformer (“DIET”) models, Bidirectional Encoder Representations from Transformers (“BERT”) based models, Convolutional Neural Networks (“CNNs”), including future versions of any of these or other intent classification models, and the trained ML model utilized by the generative response process 118 may be a LLM such as LaMDA (such as Google Gemini), ChatGPT-3, ChatGPT-3.5, ChatGPT-4, DeepMind Sparrow, Claude 3, including future versions of any of these or other LLMs, to implement the techniques described herein.

Continuing with FIG. 1, client devices 130A-130N may initiate a virtual communication session hosted by the virtual assistant platform 110 by connecting, via network 140, to the virtual assistant platform 110 and inputting a text input into a chat window provided by a graphical user interface displayed on the client devices 130A-130N by the virtual assistant platform 110. In some cases, the interacted graphical user interface may employ speech-to-text functionality where a user of one of the client devices may speak into the interface and the speech may be converted to text input using any conventional speech-to-text functionality software (text inputs in the form of typed text or text inputs converted from speech may collectively be referred to herein as “requests”).

Client devices 130A-130N, such as client device 130A, may want to initiate a virtual communication session for a variety of reasons. For example, client device 130A may want to obtain account information about an account associated with a user of client device 130A. In some instances, the account may be associated with a financial institution and the user may want to obtain information from the virtual assistant platform 110 about one or more of an account balance, withdrawal/deposit history, information about opening a new account, account and/or routing numbers associated with the account, overdraft fees, and so on. Additionally, a user of client device 130A may have a question about their account or a question about how to perform a certain action within their account (e.g., obtain a balance, check for pending deposits, change a correspondence address associated with the account, and so on). Moreover, a user of the client device 130A may have more general questions that they desire guidance on. In some examples, the general questions can relate to general questions concerning their personal finances such as “how can I save money better” or “what is the best route to achieving a certain financial goal.” To obtain answers and guidance to these requests, client devices 130A-130N, such as client device 130A, initiates a virtual communication session with virtual assistant platform 110 and the provides the request to the virtual assistant platform 110.

Once a request is received by virtual assistant platform 110, one or more instances of utterance analysis process 114, default response process 116, and/or generative response process 118 are allocated by the virtual assistant platform 110 to the particular virtual communication session associated with the particular client device 130 (e.g., client device 130A, client device 130B, etc.). The request may first be received by the utterance analysis process 114. Utterance analysis process 114 may perform various processing steps on the request to verify the format of the request and to determine an intent associated with the request. For instance, utterance analysis process 114 may perform a character threshold analysis on the request. This can include determining a number of characters associated with the request. If the number of characters satisfies a threshold, the processing steps associated with the virtual assistant platform 110 may continue. If the number of characters does not satisfy a threshold, then the virtual assistant platform 110 may output an indication of non-compliance to the client device 130. Limiting the response generation by the virtual assistant platform 110 to requests that satisfy a predefined threshold improves the accuracy of the virtual assistant platform 110 in generating a response that directly addresses the corresponding request. For instance, and as described in more detail with respect to generative response process 118, generative models, may have the potential to output text that is not directly related to the request, or the language model may deviate from the constraints in the prompt. Such deviations in language model response generation are often referred to as hallucinations, and hallucinations may be even greater in the case where requests are longform paragraphs including multiple questions, requests, thoughts, etc. Limiting the request to a predefined character threshold can help limit the generative model's propensity to hallucinate (or reduce or eliminate the generative model's propensity to otherwise become compromised.

If the request satisfies the character threshold analysis or is otherwise compliant for the virtual assistant platform 110, utterance analysis process 114 may next determine an intent associated with the request. As mentioned previously, utterance analysis process 114 may include one or more trained ML models to perform utterance analysis on the request. For instance, the one or more trained ML models may be trained to determine an intent associated with the request. The intent of the request may refer to the underlying purpose or goal of the request associated with the user's text (or audio) input. As previously mentioned, utilizing one or more ML models for intent determination is a core component of NLU systems that enables virtual assistant applications such as chatbots, virtual assistants, and voice interfaces, such as the virtual assistant hosted by virtual assistant platform 110, to respond appropriately to the request. The ML model of the utterance analysis process 114 usable for NLU may be trained on a dataset of requests paired with a corresponding predefined intent. The ML model of utterance analysis process 114 learns to extract relevant features from the request, such as keywords, phrases, pairings and orders of words, and grammatical structure. Based on the extracted features, the ML model may classify the request into one or more intents associated with an action or goal of the user. The utterance analysis process 114 may then compare the determined intent of the utterance with a list of predefined intent labels. Depending on the type of application, and in the case of a financial enterprise, the predefined intent labels may be, for example, checking the account balance, learning about investment products, obtaining card benefits, viewing a paystub, checking for a taxation identification number, approve a transaction, and so on.

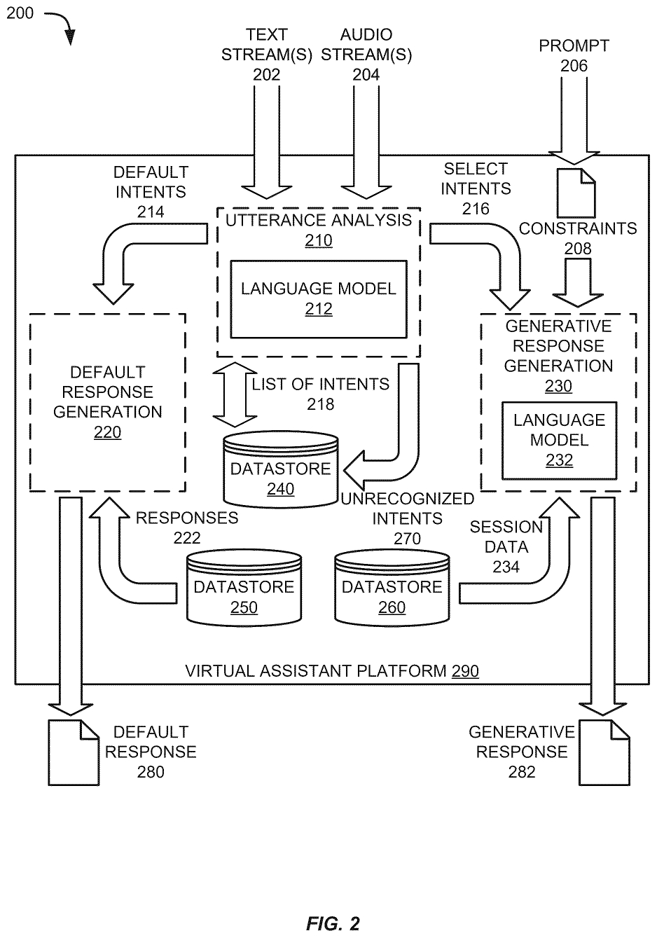

Depending on the determined intent from the utterance analysis process 114 and the corresponding comparison to the list of predefined intent labels, the request may be routed to a variety of different processing operations within the virtual assistant platform 110. For a subset of intents included in the predefined list of intent labels, the virtual assistant platform may route the request to the default response process 116 which may be operable to handle and provide responses to default intents. A described in more detail with regard to FIG. 2, the default intents include intents where the virtual assistant platform has a predefined response stored (e.g., in a datastore). In this case, the default response process 116 retrieves the predefined response associated with the respective default intent and provides the default response for display on the respective client device.

For another subset of intents included in the predefined list of intent labels, the virtual assistant platform 110 may route the request to the generative response process 118. Generative response process 118 may employ a second trained ML model, such as a LLM like Google Gemini, ChatGPT-3, ChatGPT-3.5, ChatGPT-4, DeepMind Sparrow, Claude 3, including future versions of any of these or other LLMs, to provide a generative response to the request. The generative response generation by generative response process 118 is described in more detail below with respect to FIG. 2, but in general, the second trained ML model used by generative response process 118 accepts natural language queries and prompts to generate a corresponding text output.

In some cases, the utterance analysis process 114 may determine an intent associated with the request that is not included in the predefined list of intent labels. In this case, the determined intent may be labeled as unrecognized. Limiting the response generation by the virtual assistant platform 110 (e.g., default responses or generative responses) to intents that are only included in the predefined list of intent labels improves the accuracy of the virtual assistant platform 110 in generating a response that directly addresses the corresponding request. For instance, generative models, such as the language model used by generative response process 118, have the potential to output text that is not related to the input request or the language model may deviate from the constraints in the prompt. Such deviations in language model response generation are often referred to as hallucinations. To limit the generative model's propensity to hallucinate, unrecognized intents, e.g., intents which may be abstract or beyond the training data of the generative models, are labeled as unrecognized. In the case of an unrecognized intent, the virtual assistant application 110 may provide an indicated to the client device 130 to re-phrase the question, ask the question another way, or otherwise indicate to the client device 130 that the virtual assistant is not able to provide a response to the particular request.

Also included in FIG. 1 is a remote service provider 120. Remote service provider 120 also may include one or more language models, such as language model 122. Similar to the language models included in utterance analysis process 114 and generative response process 118, language model 122 may also be a ML model of any suitable type to perform the techniques described herein. For example, language model 122 may be an intent classification model of any suitable such (e.g., DIET models, BERT based models, CNNs, and so on) or language model 122 may be an LLM of any suitable type (e.g., Google Gemini, ChatGPT-3, ChatGPT-3.5, ChatGPT-4, DeepMind Sparrow, Claude 3, and so on), including future versions of any of these or other ML models, to perform utterance analysis on a particular request received from a client device or to provide a generative response to the request.

Remote service provider 120 is connected via network 140 to the virtual assistant platform 110. In some examples, instead of the virtual assistant platform 110 utilizing one or more servers 112 to allocate processes, such as generative response process 118, to perform the virtual assistant communication operations, one or more of utterance analysis process 114 or generative response process 118 may access language model 122 hosted by remote service provider 120. In these examples, language model 122 need not be incorporated into the virtual assistant platform 110. Rather, the language model 122 can be a remotely accessible external resource usable by the one or more components of the virtual assistant platform 110 to facilitate the virtual communications session.

After the request is processed and a response is generated, e.g., by virtue of providing a predefined response to a default intent, a generative response to a select intent, or an indication that the determined intent is unrecognized, the virtual assistant platform 110 monitors for additional requests from the client devices 130A-130N. If additional requests are received, the virtual assistant platform 110 begins the processing steps again by performing utterance analysis on the request using utterance analysis process 114, determining an intent associated with the request, routing the request to the appropriate default response process 116 or generative response process 118, and so on. The provided responses and the interaction with the client devices 130A-130N continues for the duration of the virtual communication session until the client devices 130A-130N disconnect (e.g., after a period of inactivity, manual disconnection, etc.).

Referring now to FIG. 2, FIG. 2 is an example data flow diagram 200 for a virtual assistant platform 290 that that provides for utterance analysis for selective virtual assistant responses. The virtual assistant platform 290 in this example has been configured to host a virtual communication session between one or more client devices, such as client device(s) 130A-130N described with respect to FIG. 1. The virtual assistant platform 290 includes utterance analysis 210 including language model 212 for determining an intent associated with a received request from text stream(s) 202 and/or audio stream(s) 204. Utterance analysis 210 may access at least one datastore, such as datastore 240, of virtual assistant platform 290 to retrieve a list of intents 218. As described with respect to FIG. 1, the list of intents 218 may refer to a predefined list of intent labels that are associated with intents that the virtual assistant platform 290 is capable of providing or generating responses to. Based on the determined intent that is determined using the language model 212 of utterance analysis 210, the determined intent is compared to the list of intents 218 and classified as a default intent(s) 214, select intent(s) 216, or unrecognized intent(s) 270. Depending on the classification of the determined intent, the virtual assistant platform 290 routes the request to the appropriate response generation engine, e.g., default response generation 220 or generative response generation 230. Each response generation engine has been configured to provide a response to the request associated with the text stream(s) 202 and/or audio stream(s) 204 for output and display on the client device(s) 130A-130N. In the case of default intent(s) 214, default response generation 220 generates and outputs default response 280, and in the case of select intent(s) 216, generative response generation 230 generates and outputs generative response 282. After a corresponding response is generated an output (e.g., default response 280 or generative response 282), virtual assistant platform 290 may process additional requests from text stream(s) 202 and/or audio stream(s) 204 for the entirety of the virtual communication session with the client device(s) 130A-130N.

Beginning at the top portion of the data flow diagram 200 of FIG. 2, virtual assistant platform 290 may receive a request from a user of a client device, such as client device(s) 130A-130N. The request could be associated with an action that the user wishes to make, a question the user has, advice the user wishes to receive, and so. In some cases, the request could be associated with financial topics such as savings guidance, investment information, banking information, and so on. In some examples, the request is in the form of a text input and is received by virtual assistant platform 290 as text stream(s) 202. In this example, the text stream(s) 202 corresponds to a text input that is typed by the user into a graphical user interface of the client device using suitable hardware such as a keyboard. The text stream(s) 202 could be in various forms such as in sentence form, paragraph form, bullet points, and so on. In other examples, virtual assistant platform 290 may receive the request as audio stream(s) 204 where a user is speaking into a microphone incorporated into the client device 130. The virtual assistant platform 290 may employ various speech-to-text functionality to convert the audio stream(s) 204 into a text input for processing. The various forms of inputs in their text form (e.g., text stream(s) 202 or audio stream(s) 204) are collectively referred to herein as “request(s).”

The request is received by the utterance analysis 210 block of virtual assistant platform 290. Utterance analysis 210 block of virtual assistant platform 290 includes one or more language models, such as language model 212. Similar to the language models described with respect to FIG. 1, language model 212 may be referred to an intent classification model, which may be a trained ML model of any suitable type. Example intent classification models include DIET models, BERT based models, CNNs, and so on. Before performing the intent analysis on the request, and to improve the reliability of virtual assistant platform 290, one or more various pre-filtering checks may be performed on the request. For example, and according to one particular example, utterance analysis 210 block may determine a number of characters in the request. If the number of characters satisfies a threshold, the process continues. Limiting the number of characters in the request reduces the propensity of a generative model to hallucinate or otherwise generate responses that are not relevant, not related to, or are non-responsive to the request.

If the request satisfies the character threshold analysis or is otherwise compliant based on one or more other parameters set by the virtual assistant platform 290, utterance analysis 210 employes language model 212 to determine an intent associated with the request. The language model 212 may be a ML intent classification model trained on a dataset of user requests paired with their corresponding intent labels. The language model 212 learns to extract relevant features from the text, such as keywords, phrases, and grammatical structure. Based on the extracted features, language model 212 may classify the request into one or more intents associated with an action or goal of the user. The determined intent as determined by language model 212 corresponds to the underlying purpose or goal of the request. In some examples, there may be one or more intents for a single request. For instance, a first intent associated with a request may describe a high-level category associated with the request, and according to one particular example, the high-level categories may be financially related such as “accounts,” “investments,” “credit cards,” and so on, each of which include several sub-intent categories, such as “checking account,” “savings account,” “real estate investments,” “credit card benefits,” and so on. Additionally, or alternatively, the language model 212 can also include one or more unsupervised ML models trained with unlabeled training data, such as unlabeled training requests. During training of the unsupervised language model 212, language model 212 learns semantic meanings of the unlabeled training data from certain intent categories. Upon receiving a request during inference, the trained language model 212 determines semantic similarities between the request and the unlabeled training data to determine an intent.

After the utterance analysis 210 determines an intent associated with the request, utterance analysis 210 retrieves list of intents 218 from datastore 240. List of intents 218 includes a list of predefined intents that have been prelabeled by the virtual assistant platform 290 as intents that the virtual assistant platform 290 is capable of generating a response for. Additionally, list of intents 218 can include one or more sub-lists within the list of intents 218. For example, list of intents 218 can include a sub-list of default intents 214. Default intents, as described in more detail below, correspond to intents which the virtual assistant platform 290 has a predefined response for. The list of intents 218 can include another sub-list of select intents 216. Select intents 216 correspond to intents where the virtual assistant platform 290 does not have a predefined response, but where the virtual assistant platform 290 is able to use a generative model to produce a generative response to the request. Thus, utterance analysis 210 compares the determined intent of the request to the various sub-lists in list of intents 218 to classify the determine intent as either a default intent 214 or a select intent 216.

In some cases, the determined intent will not match to either a default intent 214 or a select intent 216. In this case, the utterance analysis 210 may label the determined intent as an unrecognized intent 270. Unrecognized intents 270 may be stored back into datastore 240 for future processing and utilization. For example, when a number of unrecognized intents (e.g., language model 212 has determine an unrecognized intent a certain number of times) satisfies a threshold, the language model 212 may be retrained with the requests associated with the unrecognized intents such that the language model 212 is able to provide a response (default or generative) to such unrecognized intents. In other examples, the language model 212 may be retrained periodically on improved training data, such as new requests. Thus, language model 212 provides accurate and effective intent predictions and is dynamically improving and learning based on new user requests.

In one example, the unrecognized intents 270 stored in datastore 240 may be clustered using one or more clustering algorithms (e.g., k-means clustering, Density-Based Spatial Clustering of Applications with Noise (“DBSCAN”), hierarchical DBSCAN (“HDBSCAN”), spectral clustering, Gaussian Mixture Models (“GMM”), and so on) to cluster the unrecognized intents 270 into one or more clusters, where each respective cluster includes a subset of the unrecognized intents 270. When a subset of unrecognized intents in a respective cluster satisfy a threshold (e.g., a number of unrecognized intents in a cluster exceeds a threshold), the virtual assistant platform 290 may assign a new select intent to the respective cluster. The new select intent may be added to the select intents 216 of the list of intents 218. Additionally, the language model 232 may then be fine-tuned based in part on the updated list of select intents 216.

In the case where the determined intent matches a default intent 214, the request and the corresponding determined intent is provided to default response generation 220. Default response generation 220 includes one or more processors operable to provide default response 280. As mentioned previously, default intent 214 correspond to intents where the virtual assistant platform 290 has a predefined response. The predefined responses, illustrated in FIG. 2 by responses 222, are stored in datastore 250 which is coupled to default response generation 220. Default response generation 220 may retrieve the appropriate predefined response from datastore 250 that corresponds to the default intent 214 that matches the determined intent. Once retrieved, default response generation 220 may provide the response 222 as the default response 280 for display on the graphical user interface of the client device 130. The responses 222 stored in datastore 250 may be updated, such as the case where new intents are added to the default intents 214 sub-list of the list of intents 218. Additionally, and although datastore 250 is illustrated as being included in virtual assistant platform 290, it will be appreciated that datastore 250 may be a remote storage location, such as in a cloud computing system. Additionally, or alternatively, one or more datastores included in FIG. 2 (e.g., datastore 240, 250, 260 may be consolidated into a single datastore that may be incorporated into virtual assistant platform 290 or remotely accessible by virtual assistant platform 290).

In the case where the determined intent matches a select intent 216, the request and the corresponding determined intent is provided to generative response generation 230. Generative response generation 230 includes one or more language models, such as language model 232. As mentioned with respect to FIG. 1, language model 232 may be a ML model of any suitable type that is trained to generate responses to requests. For instance, language model 232 may be a LLM such as Google Gemini, ChatGPT-3, ChatGPT-3.5, ChatGPT-4, DeepMind Sparrow, Claude 3, including future versions of any of these or other LLMs.

Because generative response generation 230 employs any suitable ML model or LLM which accepts natural language queries and prompts, in some examples language model 232 may be provided with prompt 206 including constraints 208 to enable the generated response 282 to be tailored according to the preferences of a particular user or administrator of the virtual assistant platform 290. For example, constraints 208 included in prompt 206 may include one or more instructions to provide guidance to the language model 232 in generating the generative response 282. These constraints 208 can include using a particular language (e.g., English), maintaining the same sentence structure as the request, outputting the generative response 282 in a certain format (e.g., a table, list, paragraph). The constraints 208 may also include general guidance to the language model 232 about the language model's role in the response generation such as “You are an excellent assistant for a financial institution.”

In some examples, constraints 208 may also point the language model 232 to additional resources to help aid the language model 232 in generating a response to the request. For example, one constraint that may be included in the prompt 206, may instruct the language model 232 to consider session data 234 stored in datastore 260. Session data 234 may be data associated with a publicly facing website of an enterprise that maintains the virtual assistant platform 290. Additionally, session data 234 may refer to a datastore of select documents stored in datastore 260. These documents can include terms and conditions, fee schedules, etc. associated with an enterprise. Moreover, session data 234 may be associated with specific account information associated with a user of the client device of the virtual communication session. For instance, a user may access the virtual assistant platform 290 via a mobile application on client device 130. As part of initiating the virtual communication session, the user may be required to provide login credentials to login to an account associated with the enterprise hosting the virtual assistant platform 290. When the user submits a request, session data 234 may correspond to any account information accessible in their user account. It will be appreciated that prompting of the language model 232 with prompt 206 will help tailor the generative response 282. Additionally, it will be appreciated that any one or more of the constraints 208 described above may be omitted in some examples or may be ignored by the language model 232 and merely serve as guidance to the language model 232. Moreover, it will be appreciated that more than one prompt may be provided to language model 232 of generative response generation 230. For instance, language model 232 may have a default prompt specifying general guidance and context to the language model 232. This prompt may be predetermined by a system administrator of the virtual assistant platform 290, and as such, the default prompt may be inherent to the virtual assistant platform 290. In these examples, prompt 206 may be considered an external input to the virtual assistant platform 290 that may adjust, modify, or otherwise provide additional instructions and constraints to the language model 232.

As mentioned previously with respect to FIG. 1, generative models, such as language model 232, may have a propensity to hallucinate, such as by generating output that is unrelated to the request or otherwise incomprehensible. To help reduce the likelihood of such hallucinations, post-filtering checks may be performed by generative response generation 230 before the generative response 282 is displayed on the client device 130. One such post-filtering check involves computing a confidence score associated with the response generated by the language model 232 and performing a threshold analysis. More specifically, after generating a response, generative response generation 230 may generate a confidence score for the response (e.g., using probabilities, log probabilities, the softmax function, or using other similar confidence metrics). The confidence score may be interpreted as a reliability and accuracy level of the language model 232 prediction. In other words, the confidence score represents how well the language model 232 believes that the request was appropriately answered. After generating the confidence score, the confidence score may be compared to a threshold. In some examples, if the confidence score is greater than the threshold, the threshold is satisfied. In this case, the generative response generation 230 outputs the response provided by the language model 232 as the generative response 282. In some examples, if the confidence score is less than the threshold, the threshold is not satisfied. In these cases, the generative response generation 230 can either output an indication that the request could not be processed, or the language model 232 may be re-prompted to generate a new response. During re-prompting, one or more additional constraints 208 may be added to prompt 206 instructing the language model 232 where the language model 232 went astray and/or to attempt to respond to the request again. In some examples, additional thresholds may be used. For example, confidence scores for multiple generative responses 282 may be established to evaluate a difference between the respective confidence scores for the multiple generative responses 282. If the difference between the multiple generative responses 282 satisfies a threshold, the generative response generation 230 can output the generative response with the highest confidence score. One of ordinary skill in the art would recognize many variations, modifications, and alternatives.

After the request is processed and a response is generated, e.g., by virtue of providing default response 280, generative response 282, or an indication that the determined intent is unrecognized or unable to be processed, the virtual assistant platform 290 monitors for additional inputs (e.g., text stream(s) 202 or audio stream(s) 204) from the client device 130. If additional requests are received, the virtual assistant platform 290 begins the processing steps again at utterance analysis 210. The virtual communication session continues until the client device 130 disconnects or otherwise times out (e.g., after a period of inactivity, manual disconnection, etc.).

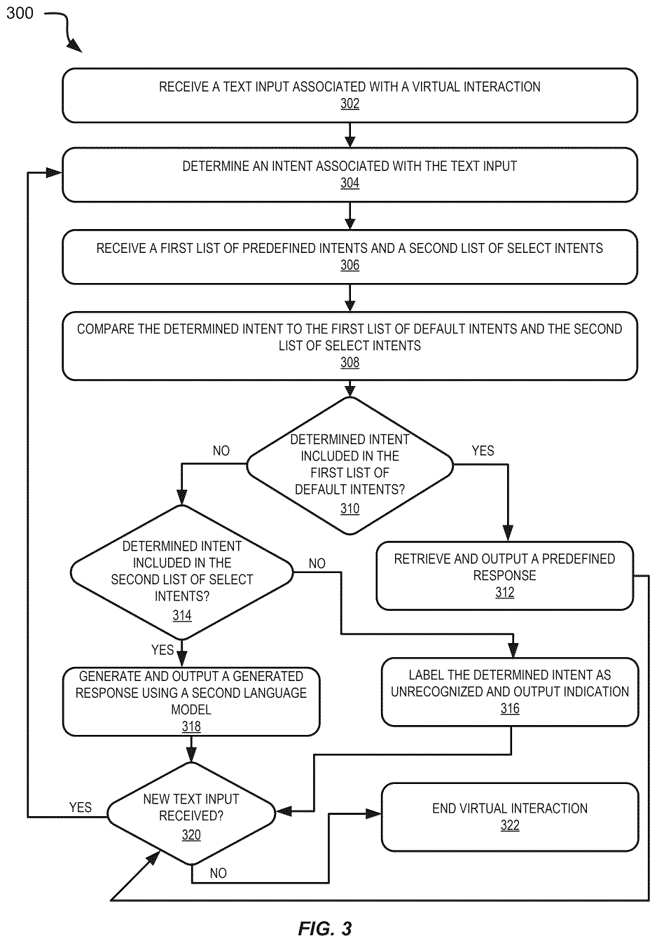

FIG. 3 is a flowchart of an example of a process 300 that provides for utterance analysis for selective virtual assistant responses. The example process 300 will be described with respect to the virtual assistant platform 290 shown in FIG. 2; however, any suitable system or platform according to this disclosure may be employed, including the example virtual assistant platform 110 shown in FIG. 1. Additionally, process 300 is provided in the order shown, but other orders or additional steps may be provided.

At block 302, utterance analysis 210 receives a text input associated with a virtual interaction. The virtual interaction can be the virtual communication session described above with respect to FIG. 2 and can include real-time online chat messages received by the virtual assistant platform 290 during an online chat session. Additionally, the text input may be received directly from a client device, such as client devices 130A-130N, in the form of text stream(s) 202. Additionally, or alternatively, the text input may be first received from a client device, such as client devices 130A-130N, in the form of an audio stream(s) 204. The audio stream(s) 204 includes recorded speech of one or more individuals. The audio stream(s) 204 may be converted to the text input using any suitable speech-to-text software incorporated into utterance analysis 210 or the virtual assistant platform 290.

At block 304, the utterance analysis 210 uses language model 212 to determine an intent associated with the text input. Language model 212 may be considered as an intent classification model that utilizes one or more ML models to perform intent classification on the text input. Example intent classification models include DIET models, BERT based models, CNNs, and so on that have been trained on a dataset of user requests paired with their corresponding intent labels. The language model 212 learns to extract relevant features from the text, such as keywords, phrases, and grammatical structure. Based on the extracted features, language model 212 may classify the request into one or more predefined intents associated with an action or goal of the user (e.g., by a comparison with predefined keywords, phrases, grammatical structure, etc.). The determined intent as determined by language model 212 corresponds to the underlying purpose or goal of the request. Additionally, or alternatively, the language model 212 can also be unsupervised ML models trained with unlabeled training data, such as unlabeled training requests. During training of the unsupervised language model 212, language model 212 learns semantic meanings of the unlabeled training data from certain intent categories. Upon receiving a request during the inference stage, the trained language model 212 determines semantic similarities between the request and the unlabeled training data to determine an intent.

At block 306, the utterance analysis 210 receives a list of intents 218 from datastore 240. List of intents 218 includes a list of intents that have been prelabeled by the virtual assistant platform 290 as intents that the virtual assistant platform 290 is capable of generating a response for. Additionally, list of intents 218 can include one or more sub-lists within the list of intents 218. For example, list of intents 218 can include a sub-list of default intents 214 (e.g., a first list of intents). Default intents 214, as described in more detail below, correspond to intents which the virtual assistant platform 290 has a predefined response for. The list of intents 218 can include another sub-list of select intents 216 (e.g., a second list of intents). Select intents 216 correspond to intents where the virtual assistant platform 290 does not have a predefined response, but where the virtual assistant platform 290 is able to use a generative model to provide a generative response to the request.

After receiving the first list of predefined intents (e.g., default intents 214) and the second list of predefined intents (e.g., select intents 216), process 300 proceeds to block 308 to compare the determined intent to the first list of default intents 214 and to the second list of select intents 216 that are included in the list of intents 218. As mentioned with respect to FIG. 2, the utterance analysis 210 is configured to make a determination as to whether the virtual assistant platform 290 is capable of providing a response to the particular determined intent.

At block 310, process 300 proceeds to make a determination as to whether the determined intent is included in the first list of default intents 214. If the determined intent is included in the first list of default intents 214, process 300 proceeds to block 312 where the default response generation 220 retrieves the response(s) 222 from datastore 250 that correspond to the default intents 214. In this case, since response(s) 222 have been preconfigured, default response generation 220 proceeds to output the predefined response 222 as the default response 280 to the text input.

If the determined intent is not included in the first list of default intents 214, process 300 proceeds to block 314 to make a determination about whether the determined intent is included in the second list of select intents 216. In the case where the determined intent is included in the second list of select intents 216, process 300 proceeds to block 318 to generate and output a generated response 282 using a second language model (e.g., language model 232) of the generative response generation 230 and based on the determine intent and the text input. As mentioned with respect to FIG. 2, language model 232 of generative response generation 230 may be a ML model of any suitable type that is trained to generate responses to requests. For instance, language model 232 may be a LLM such as Google Gemini, ChatGPT-3, ChatGPT-3.5, ChatGPT-4, DeepMind Sparrow, Claude 3, including future versions of any of these or other LLMs. Additionally, the language model 232 may receive prompt 206 including constraints 208 to enable the generated response 282 to be tailored according to the preferences of a particular user or administrator of the virtual assistant platform 290. These constraints 208 can include various instructions to guide the language model 232. Additionally, the constraints 208 may also point the language model 232 to additional resources, such as session data 234, to help aid the language model 232 in generating a response to the request. As described with respect to FIG. 2, the session data 234 can include data associated with a public facing webpage of an enterprise (e.g., a publicly accessible webpage), session data 234 can include select documents stored in datastore 260 (e.g., terms and conditions, fee schedules, etc.), session data 234 can include specific account information associated with a user of the client device of the virtual interaction, and so on. After the language model 232 generates the response, the response may undergo one or more post-filtering checks. As discussed with respect to FIG. 1, one such post-filtering check involves computing a confidence score (e.g., using probabilities, log probabilities, the softmax function, or using other similar confidence metrics) associated with the response generated by the language model 232 and performing a threshold analysis to determine a reliability factor and accuracy level of the response. If the response generated by the generative response generation 230 satisfies the one or more post-filtering checks, the response is output on the client device 130 as the generated response 282 to the request.

If the determined intent is not included in the first list of default intents 214 and the determined intent is not included in the second list of select intents 216, then process 300 proceeds to block 316 to label the determined intent as an unrecognized intent 270. Additionally, at block 316, the virtual assistant platform 290 may output an indication that the request was unrecognized or otherwise could not be answered. As mentioned with respect to FIG. 2, unrecognized intents 270 may be stored back into datastore 240 for future processing and utilization. For example, when a number of unrecognized intents (e.g., language model 212 has determined the same unrecognized intent a certain number of times) satisfies a threshold, the language model 212 may be retrained with the requests associated with the unrecognized intents such that the language model 212 is able to provide a response (default or generative) to such unrecognized intents. In other examples, the language model 212 may be retrained periodically on improved training data, such as new requests. Thus, language model 212 provides accurate and effective intent predictions and is dynamically improving and learning based on new user requests.

After a generative response 282 is generated and output (e.g., at block 318), a default response 280 is generated and output (e.g., at block 312), or an indication is output that the request could not be processed due to an unrecognized intent (e.g., at block 316), process 300 proceeds to block 320 to make a determination about whether a new text input (e.g., text stream(s) 202 or audio stream(s) 204 converted to text) is received from the user of the client device 130 by the virtual assistant platform 290. If no further text inputs are received, the process 300 proceeds to block 322 and the virtual interaction is ended. If one or more additional text inputs are received, the process 300 loops back to block 304 to determine an intent associated with the text input. Process 300 continues until the client device 130 disconnects or the virtual interaction otherwise times out (e.g., after a period of inactivity, manual disconnection, etc.).

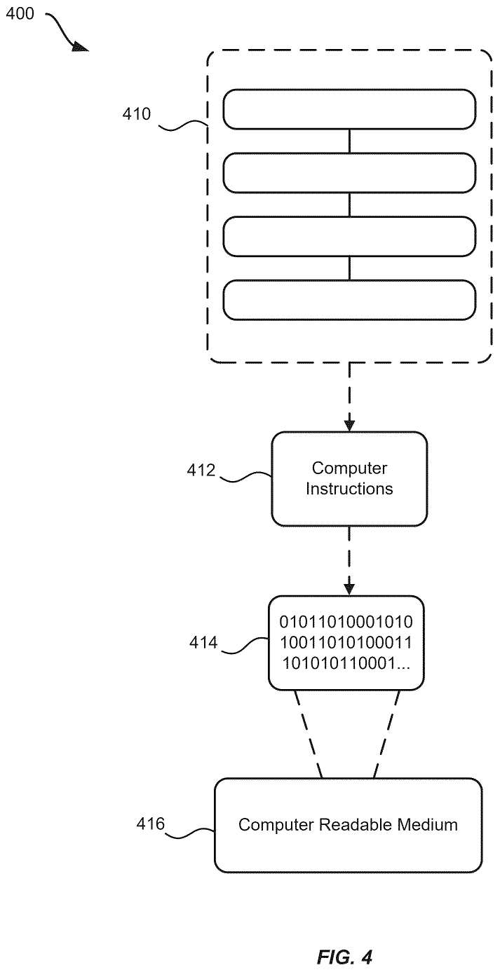

One or more of the aspects of the present disclosure include a computer-readable medium including microprocessor or processor-executable instructions configured to implement one or more embodiments presented herein. FIG. 4 is a block diagram illustrating an example computer-readable medium or computer-readable device including processor-executable instructions configured to embody one or more of the aspects set forth herein. As illustrated in FIG. 4, implementation 400 includes a computer-readable medium 416. Computer-readable medium 416 can include a CD-R, DVD-R, flash drive, a platter of a hard disk drive, and so forth, on which computer-readable data 414 is encoded and stored. The computer-readable data 414, such as binary data including a plurality of zero's and one's as illustrated, in turn includes a set of computer instructions 412 configured to operate according to one or more of the principles set forth herein.

In the illustrated implementation 400 of FIG. 4, the set of computer instructions 412 (e.g., processor-executable computer instructions) may be configured to perform a method 410, such as the process 300 of FIG. 3, for example. In another embodiment, the set of computer instructions 412 may be configured to implement a system or platform, such as the virtual assistant platform 110 described with respect to FIG. 1 or the virtual assistant platform 290 described with respect to FIG. 2, for example. Many such computer-readable media may be devised by those of ordinary skill in the art that are configured to operate in accordance with the techniques presented herein.

As used in this application, the terms “component,” “module,” “system,” “interface,” “manager,” “engine,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

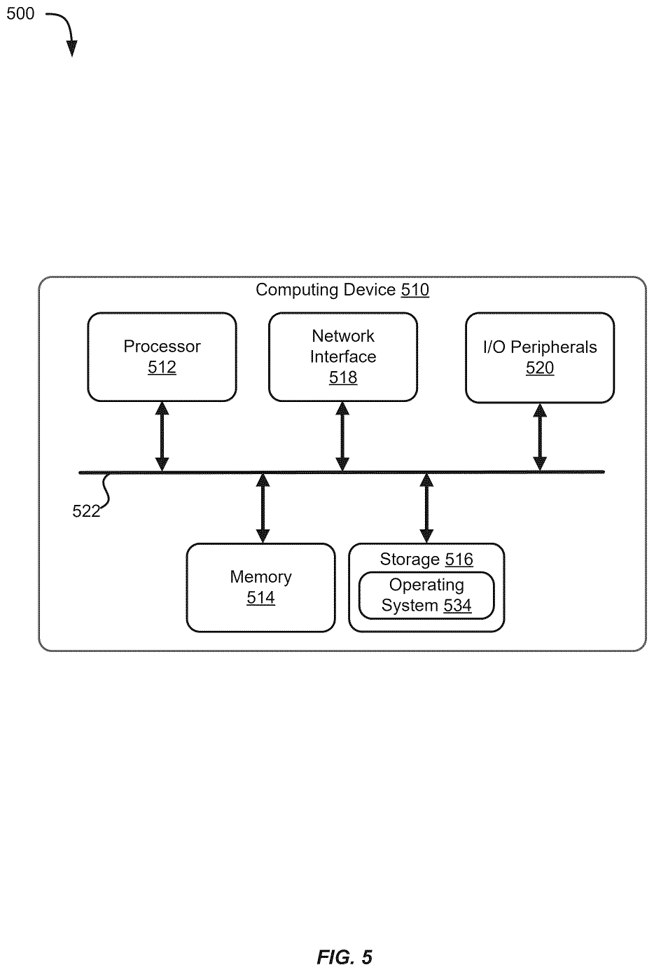

FIG. 5 and the following discussion provide a description of a suitable computing environment 500 to implement embodiments of one or more aspects of the present disclosure. The computing environment 500 of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, application programming interfaces (APIs), data structures, and the like, which perform one or more tasks or implement one or more abstract data types. Typically, the functionality of the computer readable instructions is combined or distributed as desired in various environments.

FIG. 5 is a block diagram illustrating an example computing environment 500 for utterance analysis for selective virtual assistant responses, according to one or more aspects of the present disclosure. In one configuration, the computing device 510 may include at least one processor 512 and at least one memory 514. Depending on the exact configuration and type of computing device, the at least one memory 514 may be volatile, such as RAM, non-volatile, such as ROM, flash memory, etc., or a combination thereof. Examples of processor 512 include a microprocessor, an application-specific integrated circuit (ASIC), a field-programmable gate array (FPGA), or any other suitable processing device. Computing device 510 can include one processor, such as is illustrated by processor 512 in FIG. 5, or more than one processor.

Computing device 510 may include additional features or functionality. For example, the computing device 510 may include storage such as removable storage or non-removable storage, including, but not limited to, magnetic storage, optical storage, etc. Such storage is illustrated in FIG. 5 by storage 516. In one or more embodiments, computer readable instructions to implement one or more embodiments provided herein are in the storage 516. The storage 516 may store other computer readable instructions to implement an operating system, an application program, etc. Computer readable instructions may be loaded in the at least one memory 514 for execution by the at least one processor 512, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 5, the computing environment 500 may also include a number of additional external or internal devices, for example, input or output devices. For example, computing device 510 is illustrated as including input/output (I/O) peripherals 520. I/O peripherals 520 can receive input from an input device (not shown) or provide output to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device 510.

I/O peripherals 520 may be connected to the computing device 510 via a wired connection, wireless connection, or any combination thereof. Further, the computing device 510 may include network interface 518 to facilitate communications with one or more other devices (not shown). Network interface 518 can include any device or group of devices suitable for establishing a wired or wireless data connection to one or more data networks. Non-limiting examples of the network interface 518 include an Ethernet network adaptor, a wireless network adapter, a modem, Wi-Fi adapter, Bluetooth adapter, near field communication (NFC) receiver and transmitter, and any other known wired or wireless data transmission system.

Computing device 510 also includes interface bus 522. Although only one interface bus is illustrated, computing environment 500 can include more than one interface bus. Interface bus 522 can communicatively couple one or more components of computing device 510. Computing environment 500 also includes one or more programs and/or program data that may be accessible in storage 516 by the computing device 510. For example, storage 516 can store an operating system 534 utilized to control the operation of the computing device 510. Storage 516 can also store other system application programs and data utilized by the computing device 510, such as modules implementing the functionalities provided by the virtual assistant platform 110 or the virtual assistant platform 290 or any other functionalities described above with respect to FIGS. 1-3. The storage 516 may also store other programs and data not specifically identified herein.

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method comprising:
receiving a text input associated with a virtual interaction;
determining, using a first language model, an intent associated with the text input;
receiving, by the first language model, a first list of predefined intents and a second list of select intents, wherein each predefined intent of the first list of predefined intents is associated with a respective predefined response from a list of predefined responses;
comparing the determined intent to the first list of predefined intents and to the second list of select intents to determine a respective first match or a respective second match;
responsive to determining the respective first match, retrieving and outputting the respective predefined response;
responsive to determining the respective second match, providing the text input and a prompt to a second language model; and
generating and outputting a generative response to the text input using the second language model.

2. The method of claim 1, wherein the text input comprises a plurality of words, each word comprising a plurality of characters, and wherein the method further comprises:
parsing, using the first language model, the text input to determine a total number of characters associated with the text input; and
responsive to determining that the total number of characters does not satisfy a threshold, generating and outputting an indication that the text input is non-compliant.

3. The method of claim 1, further comprising:
determining a validity of the generative response by:
computing, using the second language model, a confidence score associated with the generative response;
evaluating the confidence score against one or more threshold confidence scores;
responsive to determining the confidence score satisfies the one or more threshold confidence scores, tagging the generative response as valid and outputting the generative response; and
responsive to determining the confidence score does not satisfy the one or more threshold confidence scores, generating a new generative response using the second language model by providing an updated prompt and the text input to the second language model.

4. The method of claim 1, wherein the virtual interaction is an online chat session and wherein the virtual interaction comprises real-time chat messages in the online chat session.

5. The method of claim 1, further comprising:
responsive to generating and outputting the generative response, receiving a new text input from a user;
extracting a second intent from the new text input; and
generating and outputting, based on the second intent, a second response, wherein the second response is retrieved from the list of predefined responses or the second response is generated by the second language model.

6. The method of claim 1, further comprising:
retrieving, using the second language model, session data associated with the virtual interaction, wherein the generative response is generated at least in part based on the session data.

7. The method of claim 6, wherein the session data is extracted from a publicly accessible webpage and is associated with the determined intent.

8. The method of claim 6, wherein the session data is associated with a user account associated with a user of the virtual interaction.

9. The method of claim 1, further comprising:
responsive to determining that the determined intent is not included in the first list of predefined intents or the second list of select intents, labeling the determined intent as an unrecognized intent;
storing the unrecognized intent in a datastore comprising a plurality of unrecognized intents;
clustering the plurality of unrecognized intents using a classification model to thereby generate one or more clusters, each respective cluster comprising a subset of unrecognized intents;
responsive to the subset of unrecognized intents of a respective cluster satisfying a threshold, assigning a new select intent to the respective cluster; and
adding the new select intent to the second list of select intents.

10. The method of claim 9, wherein prior to processing the text input, the first language model and the second language model were generated by fine-tuning respective instances of a pre-trained language model, and wherein the method further comprises:
fine-tuning the second language model based in part on the new select intent.

11. The method of claim 1, wherein determining the intent is performed by comparing the text input to a set of predetermined keywords.

12. A system comprising:
one or more processors;
a memory coupled to the one or more processors, the memory including instructions that, when executed by the one or more processors, cause the one or more processors to:
receive a text input associated with a virtual interaction;
determine, using a first language model, an intent associated with the text input;
receive, by the first language model, a first list of predefined intents and a second list of select intents, wherein each predefined intent of the first list of predefined intents is associated with a respective predefined response from a list of predefined responses;
compare the determined intent to the first list of predefined intents and to the second list of select intents to determine a respective first match or a respective second match;
responsive to determining the respective first match, retrieve and output the respective predefined response;
responsive to determining the respective second match, provide the text input and a prompt to a second language model; and
generate and output a generative response to the text input using the second language model.

13. The system of claim 12, wherein the text input comprises a plurality of words, each word comprising a plurality of characters, and wherein the instructions further cause the one or more processors to:
parse, using the first language model, the text input to determine a total number of characters associated with the text input; and
responsive to determining that the total number of characters does not satisfy a threshold, generate and output an indication that the text input is non-compliant.

14. The system of claim 12, wherein the instructions further cause the one or more processors to:
determine a validity of the generated response by:
compute, using the second language model, a confidence score associated with the generative response;
evaluate the confidence score against one or more threshold confidence scores;
responsive to determining the confidence score satisfies the one or more threshold confidence scores, tag the generative response as valid and output the generative response; and
responsive to determining the confidence score does not satisfy the one or more threshold confidence scores, generate a new generative response using the second language model by providing an updated prompt and the text input to the second language model.

15. The system of claim 12, wherein the virtual interaction is an online chat session, wherein the virtual interaction comprises real-time chat messages in the online chat session, and wherein determining the intent is performed by comparing the text input to a set of predetermined keywords.

16. The system of claim 12, wherein the instructions further cause the one or more processors to:
retrieve, using the second language model, session data associated with the virtual interaction, wherein the generative response is generated at least in part based on the session data, wherein the session data is extracted from a publicly accessible webpage and is associated with the determined intent.

17. The system of claim 12, wherein the instructions further cause the one or more processors to:
responsive to determining that the determined intent is not included in the first list of predefined intents or the second list of select intents, label the determined intent as an unrecognized intent;
store the unrecognized intent in a datastore comprising a plurality of unrecognized intents;
cluster the plurality of unrecognized intents using a classification model to thereby generate one or more clusters, each respective cluster comprising a subset of unrecognized intents;
responsive to the subset of unrecognized intents of a respective cluster satisfying a threshold, assign a new select intent to the respective cluster;
add the new select intent to the second list of select intents; and
fine-tune the second language model based in part on the new select intent.

18. A non-transitory computer-readable medium embodying program code that is executable by one or more processors to cause the one or more processors to:
receive a text input associated with a virtual interaction;
determine, using a first language model, an intent associated with the text input;
receive, by the first language model, a first list of predefined intents and a second list of select intents, wherein each predefined intent of the first list of predefined intents is associated with a respective predefined response from a list of predefined responses;
compare the determined intent to the first list of predefined intents and to the second list of select intents to determine a respective first match or a respective second match;
responsive to determining the respective first match, retrieve and output the respective predefined response;
responsive to determining the respective second match, provide the text input and a prompt to a second language model; and
generate and output a generative response to the text input using the second language model.

19. The non-transitory computer-readable medium of claim 18, further comprising program code that is executable by the one or more processors to cause the one or more processors to:
retrieve, using the second language model, session data associated with the virtual interaction, wherein the generative response is generated at least in part based on the session data, wherein the session data is extracted from a publicly accessible webpage and is associated with the determined intent.

20. The non-transitory computer-readable medium of claim 18, further comprising program code that is executable by the one or more processors to cause the one or more processors to:
responsive to generating and outputting the generative response, receive a second text input from a user;
extracting a second intent from the second text input; and
generating and outputting, based on the second intent, a second response, wherein the second response is retrieved from the list of predefined responses or the second response is generated by the second language model.
